(19) United States
(12) Patent Application Publication
(10) Pub. No.: US 2017/0013337 A1
(43) Pub. Date: Jan. 12, 2017

(54) PLANT SPEAKER

(71) Applicant: Bill Costello, Concord, CA (US)

(72) Inventor: Bill Costello, Concord, CA (US)

(21) Appl. No.: 15/203,691

(22) Filed: Jul. 6, 2016

Related U.S. Application Data
(60) Provisional application No. 62/189,140, filed on Jul. 6, 2015.

(51) Int. Cl. H04R 1/02; H05B 37/02; F21V 33/00

(52) U.S. Cl. CPC H04R 1/028; H04R 1/026; F21V 33/0056; H05B 37/0236; H04R 2420/07; F21W 2131/10

(57) ABSTRACT

A plant speaker comprising a frame and a wireless speaker. The frame can resemble the petals of a flower, such that the plant speaker can visually blend in with a garden environment. The wireless speaker can be paired with a source device to play back music or other sounds from the source device.

### CLAIM OF PRIORITY

This Application claims priority under 35 U.S.C. §119(e) from earlier filed U.S. Provisional Application Ser. No. 62/189,140, filed Jul. 6, 2015, which is hereby incorporated by reference.

### BACKGROUND

Field of the Invention

The present disclosure relates to the field of audio speakers, particularly a speaker that can be wirelessly connected to another device and that has an appearance that resembles a plant.

Background

Speakers, such as Bluetooth® speakers, that wirelessly connect to other devices have become common. For example, Bluetooth® speakers are often paired with mobile phones, tablet computers, personal computers, and other devices in order to play music and sounds that originate at the device.

However, while many such speakers are designed for indoor and/or outdoor use, most still resemble conventional electronic components or have other designs that do not blend in with a natural environment.

What is needed is a speaker that wirelessly connects to other devices to play audio from those devices, but that resembles a plant such that the speaker's appearance is more suitable for outdoor environments.

### BRIEF DESCRIPTION OF THE DRAWINGS

FIG. 1 depicts a first exemplary embodiment of a plant speaker.

FIG. 2A depicts a second exemplary embodiment of a plant speaker in upright hanging orientation.

FIG. 2B depicts the second exemplary embodiment of a plant speaker in an upright orientation.

FIG. 2C depicts the second exemplary embodiment of a plant speaker in an upright orientation resting on a surface without a mounting element.

FIG. 3 depicts a block diagram of components of a plant speaker's wireless speaker.

FIGS. 4A and 4B depict front and back views of a first exemplary embodiment of a speaker module.

FIG. 5 depicts a second exemplary embodiment of a speaker module.

FIGS. 6A-6C depict steps for inserting a speaker module into an aperture in a plant speaker's frame.

FIG. 7 depicts an alternate exemplary embodiment of a plant speaker in which components of the wireless speaker are separated across the plant speaker's components.

FIG. 8 depicts an exemplary embodiment of a plant speaker comprising movable components.

### DETAILED DESCRIPTION

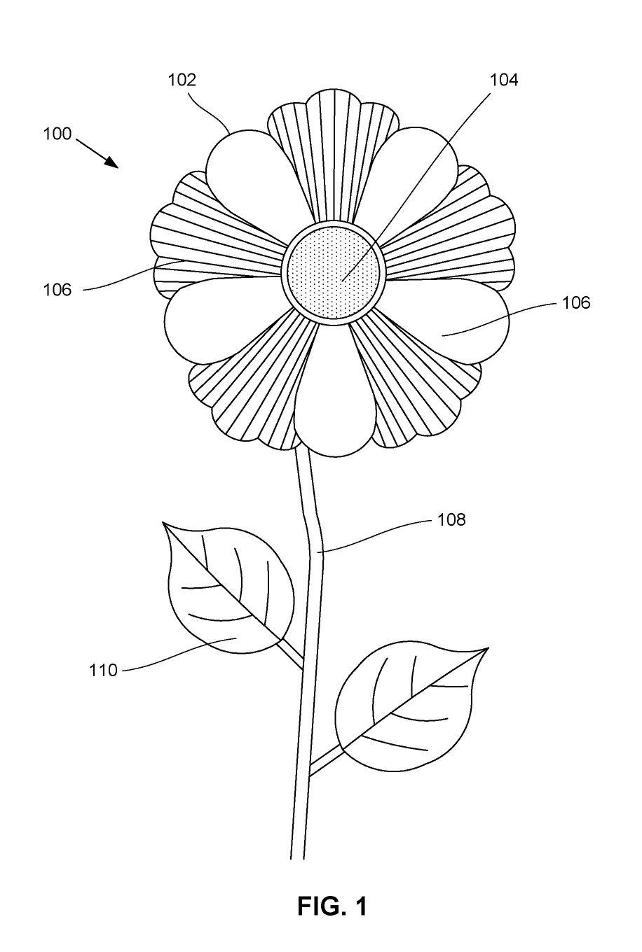

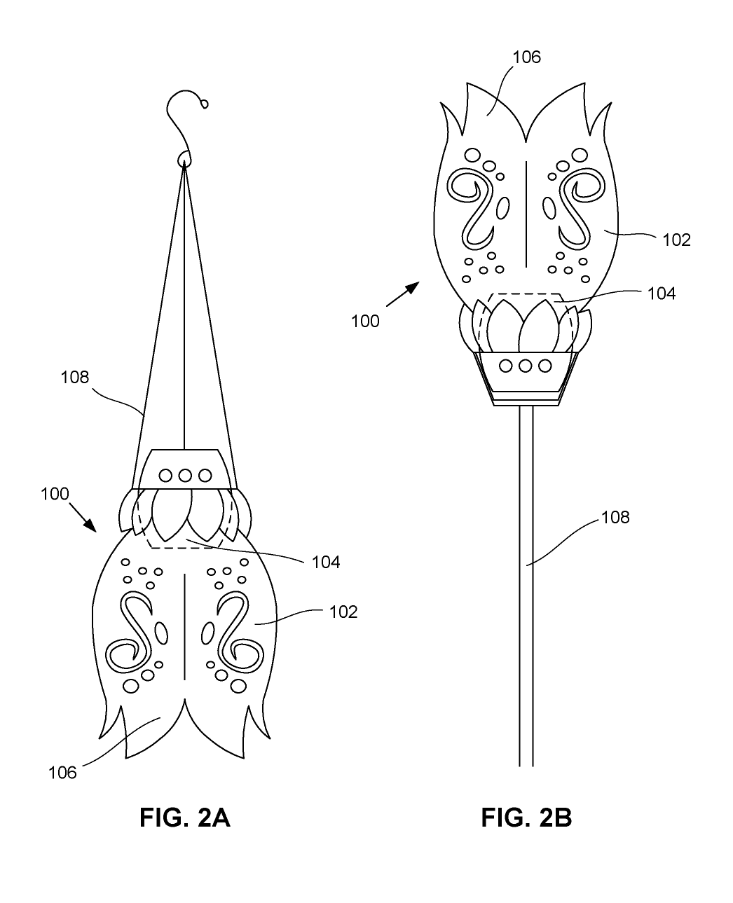

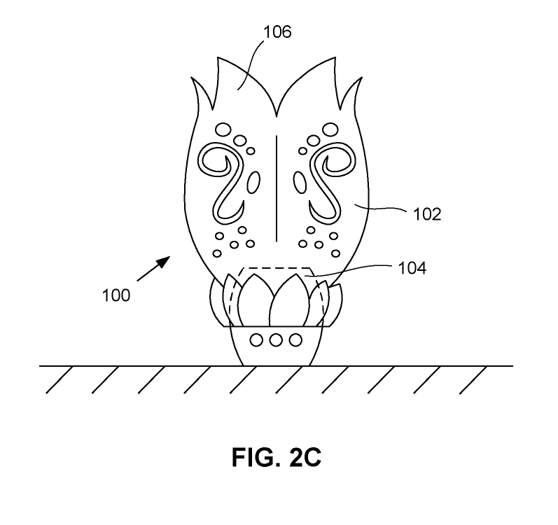

FIG. 1 and FIGS. 2A-2B depict exemplary embodiments of a plant speaker 100. A plant speaker 100 can comprise a frame 102 and a wireless speaker 104.

A frame 102 can comprise one or more petals 106. In some embodiments separately formed petals 106 can be coupled together to form the frame 102, as shown in FIG. 1. In other embodiments, the frame 102 can have a single petal 106 that has been stamped, cut, molded, or otherwise formed such that it visually appears to have multiple petals 106 even if it is a single component, as shown in FIGS. 2A-2B.

In some embodiments each petal 106 can have a substantially similar shape, size, and/or design. In other embodiments some sets of petals 106 can have varying shapes, sizes, and/or designs relative to other sets of petals 106. The petals 106 can be arranged in one or more layers. By way of a non-limiting example, the embodiment of FIG. 1 has a first layer with larger petals 106 and a second layer with narrower petals 106 positioned in front of, and/or between, the first layer of petals 106.

In some embodiments, the frame 102 and/or individual petals 106 can be formed with metals and/or metal alloys, such as copper, aluminum, bronze, or tin. In other embodiments, the frame 102 and/or individual petals 106 can be formed with plastic, glass, resin, fiberglass, or any other desired material.

The petals 106 can be formed and/or arranged such that the frame 102 has a physical appearance that at least partially resembles or emulates the appearance of a flower or other plant. By way of a non-limiting example, the petals 106 can be positioned to extend outwardly from a ring that is proximate to the center of the frame 102, such that the petals 106 encircle the ring, as shown in FIG. 1.

In some embodiments the frame 102 can have a design that substantially matches or evokes the appearance of a particular species or variety of plant, such as a particular type of flower. By way of a non-limiting example, the frame 102 can have petals 106 that resemble those of a Gerbera, a flower within the daisy family. In alternate embodiments, the frame 102 and/or its petals 106 can be designed to resemble or evoke the appearance of a plant more generally, without directly corresponding to the appearance of any particular plant. By way of a non-limiting example, the embodiment of FIGS. 2A-2B has a frame 102 shaped to evoke the appearance of a flower's petals, but that has apertures formed as stylized decorative cutouts.

In some embodiments, the frame 102 can be supported by one or more mounting elements 108. In alternate embodiments, mounting elements 108 can be absent and the plant speaker 100 can rest directly on a supporting surface without intermediate mounting elements 108.

In some embodiments, a mounting element 108 can be a stake, post, or stand that holds the frame 102 above the ground or other lower surface, as shown in FIG. 1. By way of a non-limiting example, a mounting element 108 can be a stake configured to be driven into the ground. In other embodiments, a mounting element 108 can be a string, chain, rope, or other connector that can be attached to a higher surface, such that the frame 102 hangs from the mounting element 108 and is suspended above the ground or other lower surfaces, as shown in FIG. 2A. By way of a non-limiting example, a mounting element 108 can be a chain that hangs the frame 102 from the eaves of a roof.

In some embodiments, the frame 102 can be selectively coupled with different types of mounting elements 108. By way of a non-limiting example, the frame 102 can comprise hooks, notches, brackets, or other connectors to which mounting elements 108 can be attached. As such, in some embodiments users can choose how to orient the plant speaker 100. By way of a non-limiting example, the frame 102 of the embodiment shown hanging in FIG. 2A can be removed from the chain it hangs from and then reattached to a ground stake, such that the frame 102 is oriented upward in the opposite direction as shown in FIG. 2B. As shown in FIG. 2C, the frame 102 can also be detached from mounting elements 108 and the plant speaker 100 can be positioned to rest on a tabletop or other supporting surface.

In some embodiments a mounting element 108 can also be configured to resemble portions of a plant. By way of a non-limiting example, a mounting element 108 can be a ground stake that resembles a plant's stem, as shown in FIG. 1. By way of another non-limiting example, a mounting element 108 can be a cord that resembles a vine.

In some embodiments in which the mounting element 108 resembles a portion of a plant, one or more leaves 110 can extend from the mounting element 108. The leaves 110 can be formed to resemble the leaves of a plant. By way of a non-limiting example, as shown in FIG. 1, an embodiment of the plant speaker 100 can have a frame 102 with petals 106 resembling a particular type of flower, a mounting element 108 resembling that flower's stem, and leaves 110 extending from the stem to further enhance the plant speaker's resemblance to the flower.

As discussed above, in some embodiments the plant speaker 100 can be shaped or configured such that it can be positioned to be freestanding on a tabletop or other surface without being supported by a mounting element 108. By way of a non-limiting example, FIG. 2C depicts the embodiment shown in FIG. 2A and 2B without mounting elements 108 and being placed on a surface such that it is oriented upward. In this example, the wireless speaker 104 can have a flat bottom surface that can rest on the supporting surface. In other embodiments, the frame 102 can have legs, casings, or other supporting components upon which the plant speaker 100 can rest when placed directly on a surface.

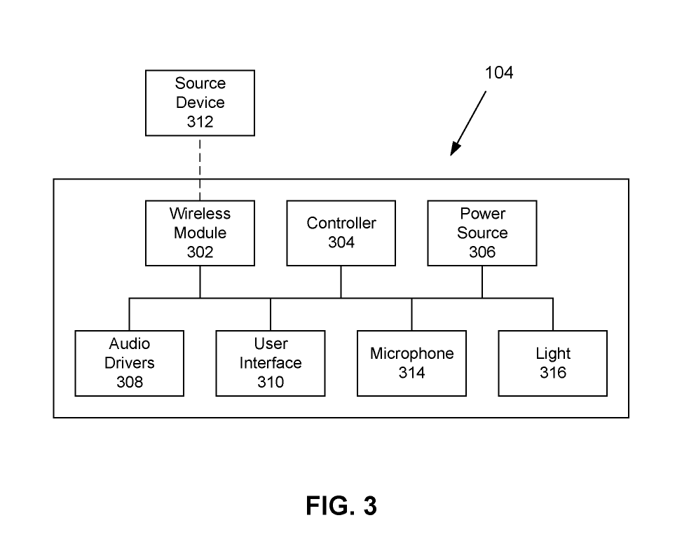

FIG. 3 depicts a block diagram of components of the plant speaker's wireless speaker 104. The wireless speaker 104 can comprise a wireless module 302, a controller 304, a power source 306, one or more audio drivers 308, and/or a user interface 310.

The wireless module 302 can comprise one or more antennas and/or radios that are configured to wirelessly send and/or receive data from one or more paired source devices 312. A source device 312 can be a mobile phone, tablet computer, personal computer, media player, or any other device with corresponding wireless components that can be paired with the wireless module 302. In some embodiments the wireless module 302 can use a Bluetooth® standard, such as Bluetooth® Core Specification 4.2, to pair with and exchange data with one or more source devices 312.

The controller 304 can be a microprocessor, integrated circuit, or other computing device that at least partially controls operation of the wireless speaker 104. In some embodiments the controller 304 can be separate from the wireless module 302, while in other embodiments, the controller 304 and the wireless module 302 can be combined into a single system on a chip or other combined device.

The power source 306 can provide power to the wireless module 302, controller 304, audio drivers 308, and/or any other electrical components within the wireless speaker 104 and/or overall plant speaker 100. In some embodiments, the power source 306 can be an internal power source or power storage component, such as a battery or solar panel housed within the plant speaker 100 that can provide electricity to other components of the wireless speaker 104. In other embodiments, the power source 306 can be a direct connection to an exterior power source, such as a cabled connection to an electrical wall outlet or separate solar panel.

In some embodiments the power source 306 can be a rechargeable battery housed within the plant speaker 100. In these embodiments, the rechargeable battery can be charged by coupling it to another power source. By way of a non-limiting example, the wireless speaker 104 can have a port to which a power cable can be attached, such as a USB cable connected to an external power source or a power cable to a separate solar panel. By way of another non-limiting example, the plant speaker 100 can comprise one or more solar panels disposed on its frame 102, mounting element 108, or leaves 110, and the rechargeable battery can be recharged with electricity provided by the solar panels.

The audio drivers 308 can be electroacoustic transducers that are configured to output audible sounds based on received electronic signals sent to them by the wireless module 302 and/or controller 304. By way of a non-limiting example, the wireless module 302 can receive audio data from a paired source device 312 and the sounds or music described by the audio data can be audibly played back by the audio drivers 308. In some embodiments the controller 304 can process the received audio data before forwarding it to the audio drivers 308 for playback. In some embodiments the wireless speaker 104 can have multiple audio drivers 308, such as woofers and tweeters.

In some embodiments, the frame 102 and/or its petals 106 can be positioned and/or oriented to amplify and/or direct sound output by the audio drivers 308. By way of a non-limiting example, some or all petals 106 can be arranged in a substantially conical shape that can direct outgoing sound in a desired direction.

The user interface 310 can be one or more controls, such as buttons or switches, through which a user can input instructions to the controller 304 or other components of the wireless speaker 104. By way of a non-limiting example, the user interface 310 can provide a button that can be held down to activate a Bluetooth® pairing mode during which source devices 312 can be paired with the wireless module 302, a power button that can turn the wireless speaker 104 on or off, and/or volume buttons that can adjust the volume level of sounds being played back by the audio drivers 308. In some embodiments, the user interface 310 can further comprise one or more components for delivering visual and/or audible feedback to users, such as lights, screens, haptic feedback devices, headphone jacks, and/or alternate speakers. By way of a non-limiting example, the wireless speaker 104 can have an LED light that illuminates when the wireless speaker 104 is powered on, and/or another LED light that illuminates when the wireless speaker 104 is paired with a source device 312.

In some embodiments, the wireless speaker 104 can further comprise a microphone 314. A microphone 314 can receive sounds at the plant speaker 100, and the microphone 314 and/or controller 304 can send audio data representing those sounds to the wireless module 302 to be wirelessly transmitted to a paired source device 312. By way of a non-limiting example, a wireless speaker 104 paired with a mobile phone over Bluetooth® can operate as a speakerphone, with audio received from the phone being played with the audio drivers 308 and audio received by the microphone 314 being sent back to the phone.

In some embodiments the wireless speaker 104, or any other element of the plant speaker 100 such as portions of the frame 102, mounting elements 108, or leaves 110, can further comprise one or more lights 316. Lights 316 can be light emitting diodes (LEDs), incandescent bulbs, compact fluorescent bulbs, or any other type of light. The lights 316 can draw power from the wireless speaker's power source 306.

In some embodiments the light 316 can be a color changing LED, or the wireless speaker 104 can comprise a plurality of lights 316 of different colors, such that wireless speaker 104 can change the color of the light it emits. By way of a non-limiting example, in some embodiments the wireless speaker 104 can pulse the light's intensity and/or change the color of the emitted light in time with music being played by the audio drivers 308. In some embodiments the controller 304 can perform audio processing on received audio data to determine the audio's tempo, such as the current song's number of beats per minute, and the controller 304 can instruct the lights to pulse intensity and/or change color at a rate corresponding to the determined tempo.

In some embodiments, multiple lights 316 of the same or different colors can be configured to rotate and/or move on the plant speaker 100, such that individual beams of light can be moved to point in different directions as they pulse, change color, and/or remain illuminated. By way of a non-limiting example, lights 316 can be mounted on a rotating orb projecting from the frame 102, or filters can be moved or rotated in front of lights 316 to change the color and/or direction of projected light. As such, multiple moving lights 316 on the plant speaker 100 can be used to project disco light effects, strobe light effects, patterned color effects, and/or other lighting effects on the surrounding environment.

In some embodiments, the wireless module 302 can further pair with and/or coordinate with wireless modules 302 in other plant speakers 100, such that separate plant speakers 100 can coordinate to play back the same audio signal, and/or play back different channels of a multichannel audio signal. By way of a non-limiting example, two plant speakers 100 can be configured such that one plays back the left channel of a stereo signal and the other plays back the stereo signal's right channel.

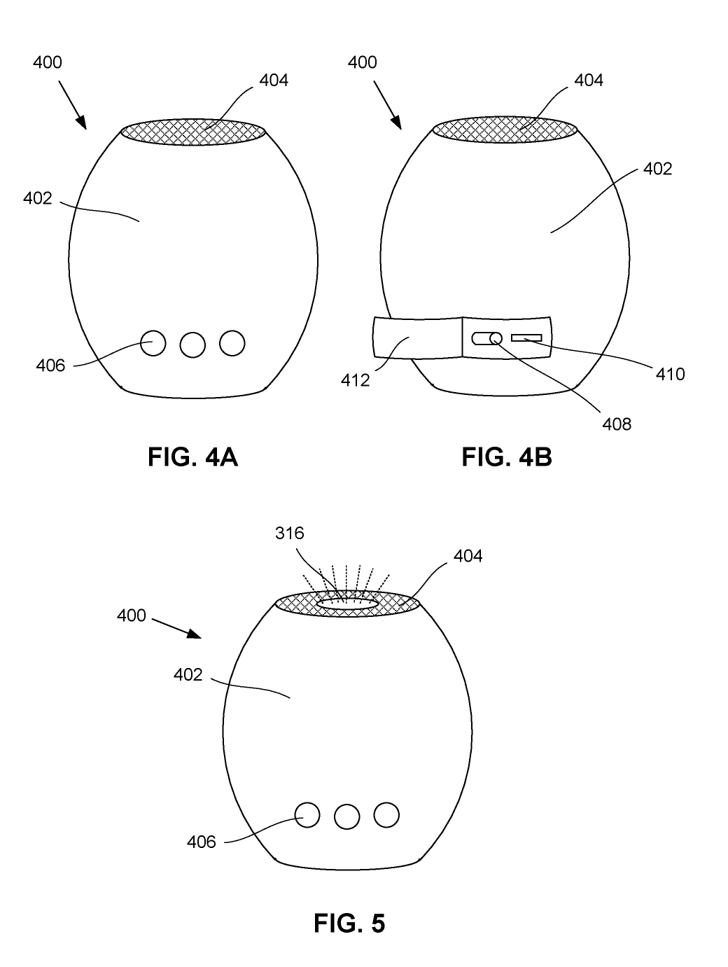

FIGS. 4A and 4B depict front and back views of a first exemplary embodiment of a speaker module 400. In some embodiments, some or all elements of the wireless speaker 104 can be housed within a self-contained speaker module 400. In the embodiment of FIG. 4A-4B, the speaker module 400 can comprise an outer housing 402 that surrounds some or all components of the wireless speaker 104. One end of the outer housing 402 can define an aperture that is spanned by a covering 404, such as a grill or mesh. The covering 404 can allow substantially unimpeded transmission of sound through the covering 404. The covering 404 can cover one or more audio drivers 308, such that sound produced by the audio drivers 308 can escape the outer housing through the covering 404.

One or more buttons 406 can be positioned on the exterior of the outer housing 402. The buttons 406 can be embodiments of one or more elements of the user interface 310, such as buttons 406 for wirelessly pairing the wireless speaker 104 with a source device 312 and/or volume control buttons 406. The outer housing 402 can also comprise a power control 408, such as a button or switch, and power port 410 to which a USB cable or other power cable can be attached to recharge a rechargeable battery within the outer housing 402. In some embodiments, elements such as the power control 408 and power port 410 can be selectively covered by a door 412, while volume controls or other buttons 406 that may be used more frequently can be exposed on the exterior of the outer housing 402.

In some embodiments the outer housing 402, covering 404, and/or door 412 can be at least partially water-resistant or waterproof or be fully or partially covered with a water-resistant or waterproof material, such that the wireless speaker 104 can be suitable for outdoor use. By way of a non-limiting example, in some embodiments the housing 402 can be a plastic shell covered with a rubber sleeve, and the buttons 406 on the exterior of the housing 402 can be operated by pressing them through the rubber sleeve.

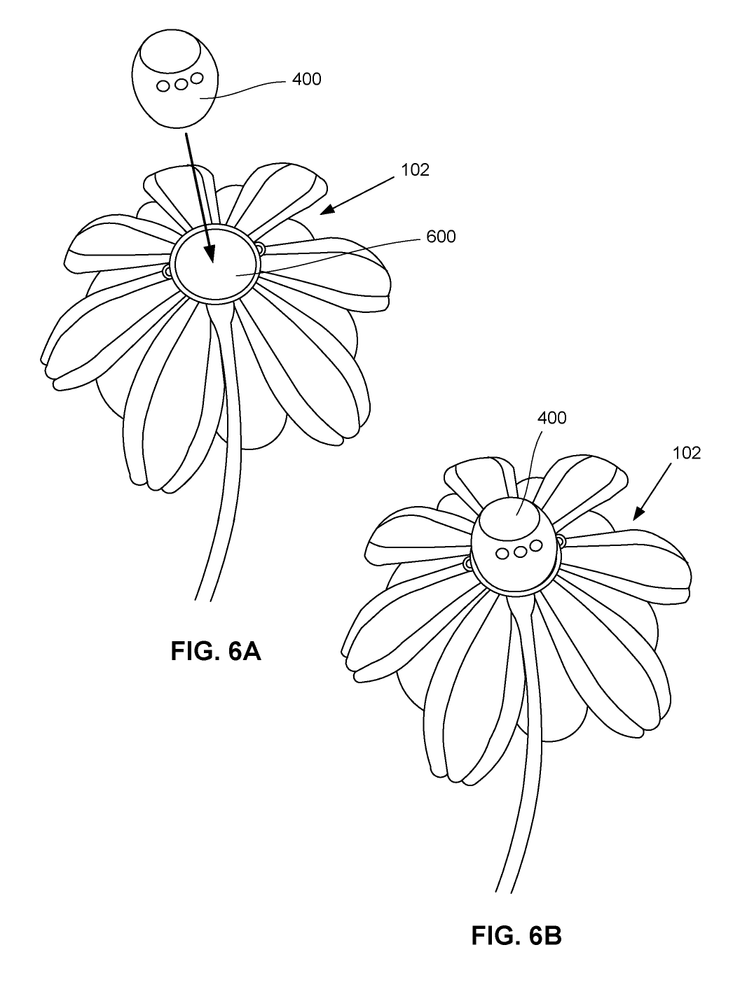

FIG. 5 depicts an alternate embodiment of a speaker module 400 that further comprises a light 316. In this embodiment, a light 316 such as an LED can be positioned substantially at the center of the covering 404. As such, the light 316 can emit light in substantially the same direction as sound is emitted by the audio drivers 308 through the covering 404.

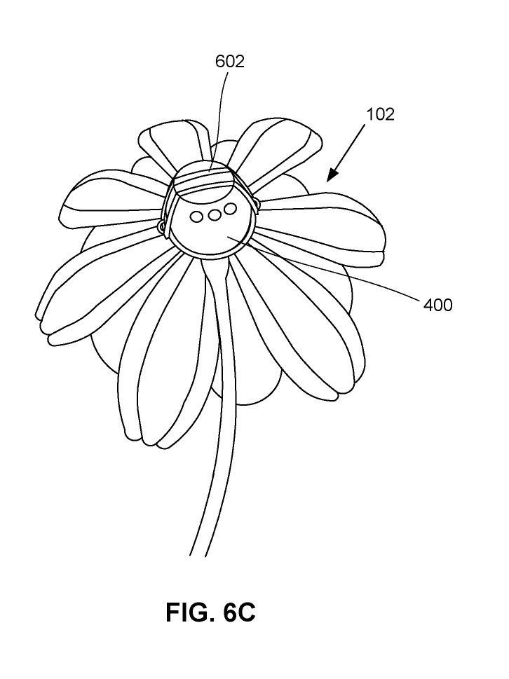

FIGS. 6A-6C depict steps for coupling a speaker module 400 with a frame 102. In some embodiments, the frame 102 can have an aperture 600 into which a self-contained speaker module 400 can be inserted as shown in FIG. 6A. By way of a non-limiting example, in embodiments in which the frame 102 has petals 106 extending outwardly from a ring surrounding an aperture 600, a speaker module 400 can be mounted within the ring's interior aperture 600 such that the petals encircle the speaker module 400.

In some embodiments, the speaker module's outer housing 402 can be shaped with a larger midsection than an end at which the covering 404 is disposed, as shown in FIGS. 4A-4B and FIG. 5. In these embodiments, the frame's aperture 600 can be sized larger than the end of the speaker module 400 at which its audio drivers 308 and/or covering 404 is disposed, but be sized smaller than the speaker module's midsection. As such, in these embodiments the end of the speaker module at which the audio drivers 308 and/or covering 404 is disposed can be passed through the frame's aperture, while its midsection can be held against the edges of the frame's aperture as shown in FIG. 6B.

In some embodiments, the speaker module 400 can be held within the frame's aperture 600 with a brace 602 configured to be coupled with the frame 102. The brace 602 can be a band, bracket, or any or any other component configured to hold the speaker module 400 against the frame 102 and within the aperture 600. By way of a non-limiting example, in some embodiments the brace 602 can be a band, such as a rubber or silicone band, that can be extended from one hook on a first side of the aperture 600 across the back of the speaker module 400 and be connected to a second hook on the opposite side of the aperture 600 as shown in FIG. 6C. The band can thus hold the speaker module 400 in place within the aperture 600.

In alternate embodiments, the speaker module 400 can be screwed into place in the frame 102, held in place with a press-fit connection into the frame 102, or be held in place in the frame 102 using adhesives, screws, bolts, and/or any other connection mechanism.

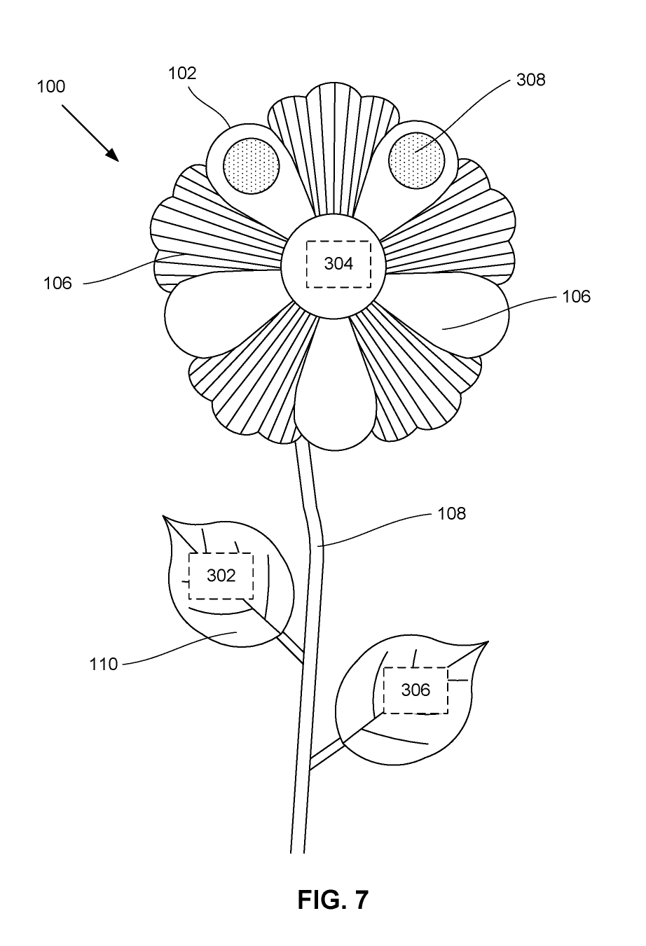

Although FIGS. 4A-6C depict embodiments in which the components of the wireless speaker 104 are held within a self-contained speaker module 400, in alternate embodiments some or all components of the wireless speaker 104 are separated and/or housed within different portions of the plant speaker 100. By way of a non-limiting example, FIG. 7 an alternate embodiment in which a controller 304 can be housed within the center of the frame 102, audio drivers 308 can be housed within one or more petals 106, a wireless module 302 can be housed with a leaf 110, and a solar panel can be disposed on another leaf 110 to serve as a power source 306. In other embodiments, any or all of the wireless speaker's components can be located in alternate locations on or within the plant speaker 100. In some embodiments, multiple audio drivers 308 can be positioned in different locations on the plant speaker 100 to reproduce stereo or other multichannel audio. In some of these embodiments, wiring can extend through the interior and/or exterior of the plant speaker 100 to connect its electronic components, such as wiring extending through the frame 102, mounting element 108, and/or leaves 110.

In some embodiments, when components of the plant speaker 100 comprise metal or other electrically conductive material, the electrically conductive materials can serve to transmit electricity and/or signals within the plant speaker 100. By way of a non-limiting example, the structure of the petals 106, mounting element 108, and/or leaves 110 can provide elements of a wireless antenna for sending and/or receiving data for the wireless module 302. In other embodiments, some components of the plant speaker 100, such as its exterior surface, can provide electrical shielding.

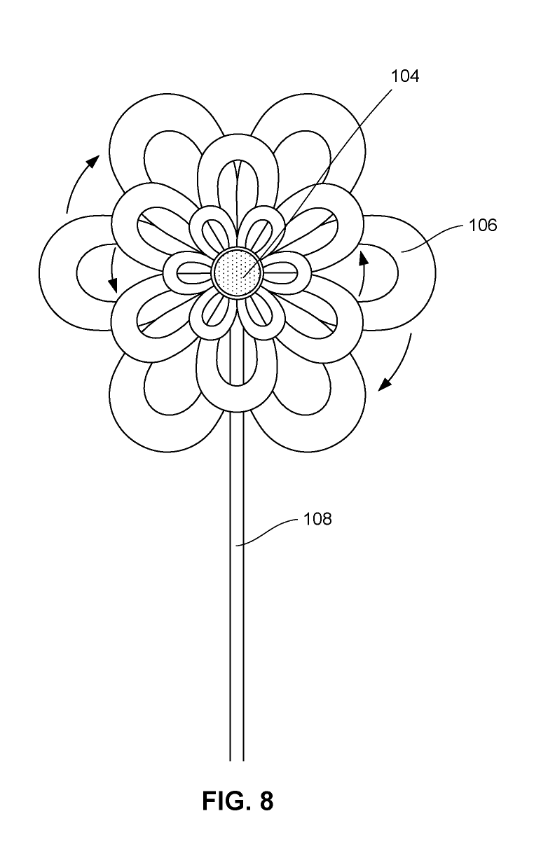

In some embodiments, the plant speaker 100 can further comprise one or more movable components. By way of a non-limiting example, FIG. 8 depicts an embodiment in which the frame 102 can have three layers of petals 106, with each layer having petals 106 of different sizes and/or shapes. In this exemplary embodiment, the petals 106 in some or all layers can be rotationally coupled around an axis at the center of the frame 102, such that they can be rotated about the axis. The wireless speaker 104, such as a speaker module 400, can also be positioned at the frame's center axis as shown in FIG. 8.

In some embodiments, movable components of the plant speaker 100 can be freely movable, such that wind can move the components. In other embodiments, the plant speaker 100 can further comprise one or more motors that can be activated to drive movement of the movable components. In some embodiments comprising a motor, the motor can be powered by the same power source as the wireless speaker 104, while in other embodiments a separate power source can power the motor.

In use, a user can place a plant speaker 100 in a desired location, such as a garden. The outward appearance of the plant speaker 100 can serve to blend in the plant speaker's appearance with its surrounding environment. The user can pair a source device 312 with the wireless speaker 104, and can play back music or other sounds from the source device 312 through the wireless speaker 104. In some embodiments, the user can pair the source device 312 with multiple plant speakers 100, such that different plant speakers 100 can output the same or different channels of the output audio to play the music or sounds from multiple locations and/or playback stereo or other multichannel audio.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A plant speaker, comprising:
a frame comprising a ring surrounding an aperture, and one or more petals extending outwardly from said ring, said petals being configured to resemble a plant; and
a speaker module housed within said aperture, said speaker module comprising a wireless module and an audio driver, said wireless module being configured to wirelessly exchange data with a source device and said audio driver being configured to receive and play back audio data from said source device via said wireless module.

2. The plant speaker of claim 1, wherein said wireless module exchanges data with said source device using a Bluetooth standard.

3. The plant speaker of claim 1, further comprising a brace extending from one position on said ring around a back portion of said speaker module to a second position on said ring to hold said speaker module within said aperture.

4. The plant speaker of claim 1, further comprising a mounting element that supports said frame.

5. The plant speaker of claim 4, wherein said mounting element is a ground stake.

6. The plant speaker of claim 5, wherein said mounting element is configured to resemble a plant stem.

7. The plant speaker of claim 4, wherein said mounting element is a suspension member from which said frame hangs.

8. The plant speaker of claim 1, wherein said speaker module further comprises a light.

9. The plant speaker of claim 8, wherein said light is configured to pulse and/or change at a rate corresponding to the tempo of said audio data.

10. The plant speaker of claim 1, wherein at least one petal is rotationally coupled to said frame such that said at least one petal rotates about an axis in said frame.

11. A plant speaker, comprising:
a frame comprising one or more petals, said petals being configured to resemble a plant;
a wireless module coupled with said frame, said wireless module being configured to wirelessly exchange data with a source device; and
an audio driver housed within said frame and electrically coupled with said wireless module, said audio driver being configured to receive and play back audio data from said source device via said wireless module.

12. The plant speaker of claim 11, wherein said wireless module exchanges data with said source device using a Bluetooth standard.

13. The plant speaker of claim 11, further comprising a mounting element that supports said frame.

14. The plant speaker of claim 13, wherein said mounting element is a ground stake.

15. The plant speaker of claim 14, wherein said mounting element is configured to resemble a plant stem.

16. The plant speaker of claim 13, wherein said mounting element is a suspension member from which said frame hangs.

17. The plant speaker of claim 11, further comprising a light coupled with said frame.

18. The plant speaker of claim 17, wherein said light is configured to pulse and/or change at a rate corresponding to the tempo of said audio data.

19. The plant speaker of claim 11, wherein at least one petal is rotationally coupled to said frame such that said at least one petal rotates about an axis in said frame.
